(19) United States
(12) Patent Application Publication
(10) Pub. No.: US 2002/0196553 A1
(43) Pub. Date: Dec. 26, 2002

(54) Off-focal plane micro-optics

(76) Inventor: Thomas M. Colandene, Springfield, VA (US)

Correspondence Address: DEPARTMENT OF THE ARMY - CECOM, INTELLECTUAL PROPERTY DIVISION, 10225 BURBECK ROAD, AMSEL LG P NVEO (MILTON LEE), FORT BELVOIR, VA, 22060-5806, US

(21) Appl. No.: 09/888,509

(22) Filed: Jun. 26, 2001

(51) Int. Cl. G02B 27/10

(52) U.S. Cl. 359/626

(57) ABSTRACT

The use of micro-optics on a substrate located in proximity to the detector focal plane array. The micro-optics are formed on the front-side and/or backside of the substrate and a micro-optic effect onto the detector elements without the need to apply micro-optics directly to the detector focal plane array.

### BACKGROUND OF THE INVENTION

1. Field of the Invention

The present invention generally relates to optics and micro-optics and more specifically, to placing micro-optics in material located near the focal plane of an optical system.

2. Description of Prior Art

Various optical systems make use of, or could make use of micro-optics located on the detector or focal plane assembly. However conventional detector arrays usually cannot be modified directly without significant cost/yield issues due to the sensitivity of the detector material and substrate layers in the detector array.

The prior art for optical systems was to place the micro-optics on the detector array by processes such as lithography and etching which could damage the detector array, increasing process complexity and reducing yield.

While the prior art has reported using micro-optics on the detector array for purposes such as improving detector fill factor, none have established a basis for a specific system and technique that is dedicated to the task of resolving the particular problem at hand. What is needed in this instance is a substrate with micro-optics on it, located near the focal plane of an optical system.

### SUMMARY OF THE INVENTION

It is therefore one object of the invention to provide micro-optics on a substrate located near the focal plane of an optical system to provide the same function as micro-optics on the detector array.

According to the invention, there is disclosed a technique of providing micro-optics located on a substrate near the detector array of an optical system. The micro-optics are formed on the surface of the substrate (front-side and/or backside) and modify the radiation impinging on the detector elements. The function of the micro-optics is provided near the focal plane without modification to the detector focal plane array itself.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an optical ray-trace for a single detector element pathway of the micro-optics for the present invention.

FIG. 2 is an optical ray-trace for a system utilizing the present invention.

### DETAILED DESCRIPTION OF A PREFERRED EMBODIMENT OF THE INVENTION

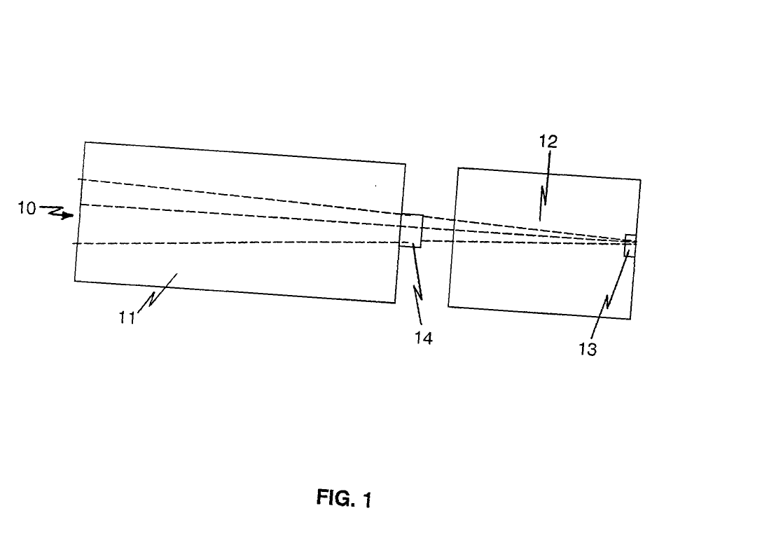

Referring now to the drawings, and more particularly to FIG. 1, there is shown an optical ray-trace for a single detector element optical pathway of micro-optic for the present invention. Input radiation 10 is received from an optical system into a substrate 11. Substrate 11 is placed on the optical axis in proximity to the focal plane detector assembly 12, including detector element 13. It is understood that while the substrate 11 cannot be physically touching the detector surface, it is desired to achieve a close proximity, approximate to the detector surface. A micro-optic, in this embodiment a microlens, 14 is shown with a ray-trace to detector element 13. The microlenses are made on the backside of substrate 11 by standard processes such as etching micro-lithography or electron beam ablation. Since the substrate is to cover the entire focal plane array, an array of microlenses is required where one microlens would be located over each detector element. The microlens is part of the substrate material that allows the micro-optic surface to be placed on substrate 11 providing the desired micro-optic function to the detector array. In this embodiment the microlenses ensure that pixel energy (which is information) remains on the detector element, thus providing improved detector fill factor. It is understood that the invention is not limited to the specific micro-optic function achieved to the detector array.

Microlenses are used on the substrate material instead of directly on the detector array. The microlenses are formed in this embodiment on the backside of the substrate and focus the radiation onto the detector elements. The microlenses may be made by such processes as micro-lithography or beam ablation. This method allows for micro-optic fabrication on the substrate instead of the detector focal plane.

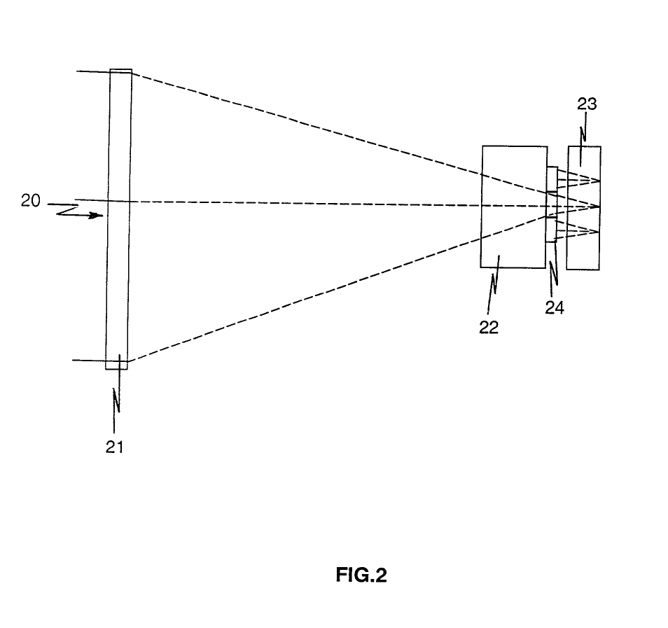

FIG. 2 is an optical ray-trace for an optical system utilized in the preferred embodiment. Input radiation 20 is received from an optical system through optics 21 and focused as shown in the detector assembly 23. Input radiation 20 is accepted into substrate 22. The optical system and microlenses achieve focus at the FPA 23 taking into account system field angles, wavelengths (bandwidth) and other optical methods used. The microlens array 24 formed on the backside of substrate 22 (shown as microlens 14 in FIG. 1) allow for focus of radiation onto detector elements for purposes such as improving detector fill factor. In the preferred embodiment, substrate 22 is placed on the optical axis in proximity to the focal plane within said optical system. A substrate is utilized in the preferred embodiment with a diffractive or refractive microlens structure.

While this invention has been described in terms of preferred embodiment consisting of a typical optical system, those skilled in the art will recognize that the invention can be practiced with modification within the spirit and scope of the appended claims.

Having thus described my invention, what I claim as new and desire to secure by Letters Patent is as follows:

1. An apparatus for providing micro-optics in a substrate located approximate to the focal plane array within an optical system comprising:
a focal plane array (FPA) detector surface, wherein input radiation from a viewed scene is received by the optical system;
a substrate with a front and back side, said backside further including a microlens, said substrate is approximate to the focal plane within said optical system, whereby there is created a micro-optic function at the detector focal plane.

2. The apparatus of claim 1 wherein said microlens is a diffractive lens structure.

3. The apparatus of claim 1 wherein said microlens is a refractive lens structure.

4. A micro-optic technique for a substrate within an optical system, comprising the steps of:
receiving input radiation from a viewed scene through an optical assembly onto a focal plane of an optical system;
providing a substrate on the optical axis in proximity to the focal plane within said optical assembly;
providing micro-optics on the substrate, whereby there is created a micro-optic effect from the substrate at said FPA detector surface.

5. The micro-optic technique of claim 4 wherein said micro-optic effect is an improved detector fill factor.
